(19) United States
(12) Patent Application Publication
(10) Pub. No.: US 2011/0203004 A1
(43) Pub. Date: Aug. 18, 2011

(54) Method and System for Electronic Publishing and Distribution of Printed Sheet Music

(76) Inventor: Eric Ziering, Newton, MA (US)

(21) Appl. No.: 13/026,224

(22) Filed: Feb. 12, 2011

Related U.S. Application Data
(60) Provisional application No. 61/337,854, filed on Feb. 12, 2010.

(51) Int. Cl. G06F 21/24

(52) U.S. Cl. 726/28

(57) ABSTRACT

Described are methods and systems, including computer program products, for distributing printed sheet music. The method includes storing a set of one or more digital-print files and a set of one or more digital-audio files in a computer-readable storage medium on a back-end server. Each digital-print file includes sheet music information associated with one of the digital-audio files. Each, digital-print file and digital-audio file is associated with one or more audio identifiers. An application programming interface (API) is provided for client systems remote from the back-end server to retrieve a list of the set of one or more digital-print files and to preview the digital-audio and digital-print files. A purchase order is received for the first digital-print file from the remote client system using the API. A digital watermark is inserted into the first digital-print file. The watermarked digital-print file is transmitted to the remote client system.

### RELATED APPLICATIONS

This application claims priority to and the benefit of U.S. Provisional Patent Application No. 61/337,854, filed on Feb. 12, 2010, the entire contents of which are incorporated herein by reference in their entirety.

### FIELD OF THE INVENTION

The invention relates generally to computer-implemented methods and systems, including computer program products, for distributing printed sheet music.

### BACKGROUND

Sheet music typically refers to hand-written or printed forms of music notation. To some sheet music is any form of music notation, tablature, and/or other means of visually displaying symbols that represent aurally perceived music. Like other forms of original works, sheet music is subject to copyright laws, which include the exclusive rights to copy and distribute the sheet music. In order to maximize the distribution of their music while complying with copyright laws, musical artists typically assign the publishing copyrights to their music to a music publishing company. The music publishing company, in turn, typically assigns the print publishing rights to the sheet music to a print publishing company, which can include arranging for the music to be transcribed into sheet music form. The print publishing company, in turn, typically distributes the printed sheet music via one or more retailers. While maximizing the distribution of their music, the multiple parties involved, from the original copyright owner to the retailers, results in high overhead costs that get passed on to the consumer in the form of more expensive sheet music.

Recent advances in computer networking technologies, including the proliferation of the World Wide Web, have led to an increase in the distribution of sheet music in computer-readable formats. Using computers, customers can now download sheet music as digital files directly from the websites of online music publishers and retail stores. However, due to copyright restrictions, online music publishers typically require customers to have special software readers that restrict access to and printing of sheet music that is only available from the online music publishers' websites.

### SUMMARY OF THE INVENTION

Existing methods and systems of distributing sheet music involve high overhead. High overhead costs result in higher costs for consumers and less royalty revenue for musical artists and thus provide an incomplete and unsatisfactory solution. Therefore, a method and apparatus that decreases the overhead costs of distribution and increases the availability of digital sheet music is desirable.

One approach to distributing printed sheet music online is to provide a transparent mechanism for customers to preview and purchase sheet music directly from musical artists' websites, or other computer network sites associated with the artists, while using a remote back-end server for storing the sheet music.

In one aspect, there is a computerized method for distributing printed sheet music. The method includes storing a set of one or more digital-print files and a set of one or more digital-audio files in a computer-readable storage medium on a back-end server. Each digital-print file includes sheet music information associated with one of the digital-audio files. Each digital-print file and digital-audio file is associated with one or more audio identifiers. The method also includes providing an application programming interface (API) for client systems remote from the back-end server to retrieve a list of the set of one or more digital-print files and to preview the digital-audio and digital-print files. The method also includes providing, to one or more front-end servers remote from the back-end server, computer network address information for accessing the API. Each of the one or more front-end servers is associated with one or more of the one or more audio identifiers. The method also includes receiving, from a remote client system using the API, a preview request for a first digital-print file in the set of one or more digital-print files. The method also includes transmitting, in response to the preview request, a digital preview file associated with the first digital-print file to the remote client system. The method also includes receiving, from the remote client system using the API, a purchase order for the first digital-print file. The method also includes inserting, in response to the purchase order, a digital watermark into the first digital-print file. The digital watermark includes licensing information associated with a user of the remote client system and the purchase order. The method also includes transmitting, to the remote client system, the watermarked digital-print file.

In another aspect, there is a computer program product tangibly embodied in a machine-readable storage device. The computer program product includes instructions being operable to cause a data processing apparatus to store a set of one or more digital-print files and a set of one or more digital-audio files in a computer-readable storage medium on a back-end server. Each digital-print file including sheet music information associated with one of the digital-audio files. Each digital-print file and digital-audio file being associated with one or more audio identifiers. The instructions are also operable to cause the data processing apparatus to provide an application programming interface (API) for client systems remote from the back-end server to retrieve a list of the set of one or more digital-print files and to preview the digital-audio and digital-print files. The instructions are also operable to cause the data processing apparatus to provide, to one or more front-end servers remote from the back-end server, computer network address information for accessing the API. Each of the one or more front-end servers being associated with one or more of the one or more audio identifiers. The instructions are also operable to cause the data processing apparatus to receive, from a remote client system using the API, a preview request for a first digital-print file in the set of one or more digital-print files. The instructions are also operable to cause the data processing apparatus to transmit, in response to the preview request, a digital preview file associated with the first digital-print file to the remote client system. The instructions are also operable to cause the data processing apparatus to receive, from the remote client system using the API, a purchase order for the first digital-print file. The instructions are also operable to cause the data processing apparatus to insert, in response to the purchase order, a digital watermark into the first digital-print file. The digital watermark includes licensing information associated with a user of the remote client system and the purchase order. The instructions are also operable to cause the data processing apparatus to transmit, to the remote client system, the watermarked digital-print file.

In another aspect, there is a system for distributing printed sheet music. The system includes a back-end server including a computer-readable storage medium. The computer-readable storage medium includes a set of one or more digital-print files and a set of one or more digital-audio files. Each digital-print file including sheet music information associated with one of the digital-audio files, each digital-print file and digital-audio file being associated with one or more audio identifiers. The back-end server includes an application programming interface (API) for client systems remote from the back-end server to retrieve a list of the set of one or more digital-print files and to preview the digital-audio and digital-print files. The system also includes means for receiving, from a remote client system using the API, a preview request for a first digital-print file in the set of one or more digital-print files. The system also includes means for transmitting, in response to the preview request, a digital preview file associated with the first digital-print file to the remote client system. The system also includes means for receiving, from the remote client system using the API, a purchase order for the first digital-print file. The system also includes means for inserting, in response to the purchase order, a digital watermark into the first digital-print file. The digital watermark includes licensing information associated with a user of the remote client system and the purchase order. The system also includes means for transmitting, to the remote client system, the watermarked digital-print file.

In other examples, any of the aspects above can include one or more of the following features. The API can communicate with a software application on a front-end server from the one or more front-end servers. The API can communicate with a software application on the remote client system. The software application can include: the computer network address information for accessing the API, at least one audio identifier from the one or more audio identifiers, and instructions being operable to cause the remote client system and/or the front-end server to communicate with the API. The software application on the remote client system can be embedded in a webpage retrieved from a front-end server from the one or more front-end servers. The at least one audio identifier can be an audio identifier associated with the front-end server. The software application on the remote client system can be retrieved from the back-end server based on the computer network address information being embedded in a webpage retrieved from a front-end server from the one or more front-end servers. The at least one audio identifier can be an audio identifier associated with the front-end server. The one or more audio identifiers can include one or more performer identifiers, one or more composer identifiers, one or more arranger identifiers, one or more genre identifiers, one or more arrangement type identifiers, or any combination thereof. The one or more performer identifiers can be associated with one or more names whose audio performances were recorded in the one or more digital-audio files, the one or more composer identifiers are associated with one or more names who wrote the music associated with the one or more digital-audio files, and the one or more arranger identifiers are associated with one or more names who transcribed the sheet music information associated with the digital-audio files.

In some embodiments, the API includes a web interface conforming to the Representational State Transfer (REST) architecture, the Simple Object Access Protocol (SOAP), or any combination thereof. The method can also include receiving, from the remote client system using the API, a request to retrieve the list of the set of one or more digital-print files. The request can include at least a first audio identifier from the one or more audio identifiers. The method can also include generating the list of the set of one or more digital-print files. The list can include each digital-print file from the one or more digital-print files with an associated audio identifier that matches the first audio identifier. The method can also include transmitting, to the remote client system, the list of the set of one or more digital-print files. Generating the list of the set of one or more digital-print files can be based on a geographic location associated with the remote client system. The list of the set of one or more digital-print files can conform to an eXtensible Markup Language (XML) format.

In some embodiments, the preview request includes a print-preview request for the first digital-print file. The digital preview file can be a digital image, and the set of one or more digital-print files can include the digital image separate from the first digital-print file. The digital preview file can include at least a portion of the first digital-print file. The preview request can include an audio-preview request for the first digital-print file. The digital preview file can include at least a portion of a first digital-audio file in the set of one or more digital-audio files. The first digital-audio file can be associated with the first digital-print file. The digital preview file can conform to a Moving Picture Experts Group (MPEG) format. The method can also include receiving, from the remote client system using the API, a second preview request for the first digital-print file. The preview request and the second preview request can include audio-preview and print-preview requests for the first digital-print file. The watermarked digital-print file can include a digital file formatted according to the Portable Document Format (PDF) standard. The licensing information associated with the user of the remote client system and the purchase order can include a unique identifier for the user of the remote client system. The method can also include receiving, from the remote client system using the API, a request to add the first digital-print file to an online shopping cart. The purchase order can be for all digital-print files in the online shopping cart.

In other examples, any of the features above relating to a method can be performed by a system, and/or a controller of the system, configured to or having means for performing the method. In addition, any of the features above relating to a method can be performed by a computer program product including instructions being operable to cause data processing apparatus to perform the method.

Any of the above implementations can realize one or more of the following advantages. The methods and systems can advantageously provide a highly efficient mechanism for delivering a large variety of sheet music products to customers. By eliminating fixed costs associated with traditional print publishing, multiple arrangements of individual compositions, each targeted towards different submarkets of customers for example, can be made available. Digital sheet music products can also be enabled to be sold through an unlimited number of websites, including those of artists, composers, fans, publishers, and record companies. In particular, any party can create an online electronic sheet music store (e.g., via a website) that is transparently hosted by a back-end server. Music can also be published and/or distributed in other digital formats, including digital audio, synthesized playback (MIDI), and karaoke. Embedding licensing information in real-time based on purchase orders advantageously limits illegal use and/or unauthorized violations of copyrights.

The details of one or more examples are set forth in the accompanying drawings and the description below. Further features, aspects, and advantages of the invention will become apparent from the description, the drawings, and the claims. The drawings are not necessarily to scale, emphasis instead generally being placed upon illustrating the principles of the invention.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a block diagram showing an exemplary network with devices relating to the distribution of printed sheet music.

FIG. 2 illustrates a flowchart depicting distribution of printed sheet music.

FIG. 3 illustrates a graphical user interface depicting a web browser on a remote client system.

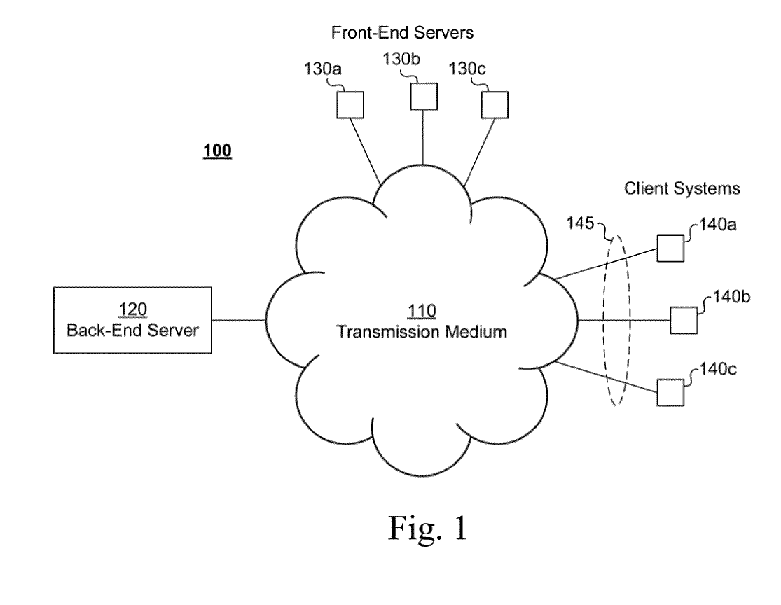

### DESCRIPTION OF THE INVENTION FIG. 1 is a block diagram showing an exemplary computer network 100 with devices relating to the distribution of sheet music. The network 100 includes a transmission medium 110, at least one back-end server 120 one or more front-end servers 130a, 130b, and/or 130c, generally 130, and/or one or more client systems 140a, 140b and/or 140c, generally 140. The transmission medium 110 is responsible for the transfer of information between one or more of the back-end server 120, one or more of the front-end servers 130, and/or one or more of the client systems 140.

The transmission medium 110 is coupled to at least one back-end server 120 and one or more front-end servers 130. The servers 120 and 130 can include, for example, web servers, application servers, media servers, and/or other software/hardware system that provides services to remote clients. The front-end servers 130 can include websites operated, managed, and/or controlled by musical artists, composers, fans, publishers, and/or record companies. For example, in some embodiments, a front-end server 130 hosts a website for a musical group (e.g., a unique website domain name for a group, a Facebook® webpage, or a Myspace® webpage). As described in more detail below, the back-end server 120 can be responsible for providing sheet music services (e.g., previewing sheet music and/or downloading sheet music) to consumer(s) using remote client system(s) 140 via the front-end servers 130. In some embodiments, an application programming interface (API) is provided on the back-end server 120 for remote client systems 1.40 to request and retrieve digital-print and/or digital-audio files stored on the back-end server 120. The API includes a set of rules and specifications that a software application uses to access the sheet music services. The software application can be executed on one of the front-end servers 130 and/or directly on one of the remote client systems 140. In some embodiments, the API is a web interface conforming to the Representational State Transfer (REST) architecture. In alternative or supplemental embodiments, the API is a web interface conforming to the Simple Object Access Protocol (SOAP).

The transmission medium 110 can be coupled to the remote client systems 140 by connections 145. The remote client systems 140 can be computers, telephones, IP phones, mobile devices (e.g., tablet devices, handheld devices, smartphones, laptop computers, and/or the like), and/or other communication devices. Connections 145 can include wired connections (e.g., electrical wires/optical fibers) and/or wireless connections.

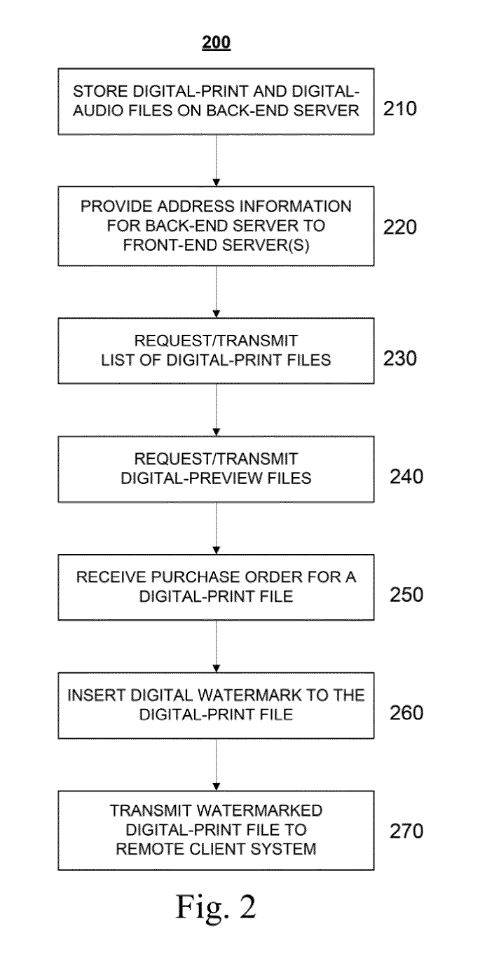

FIG. 2 illustrates a flowchart 200 depicting distribution of printed sheet music. The elements of the flowchart 200 are described using the exemplary network 100 of FIG. 1. The distribution of printed sheet music can include storing a set of one or more digital-print files and a set of one or more digital-audio files in a computer-readable storage medium (not shown) on or coupled to a back-end server 120 (210), providing, to one or more front-end servers 130, computer network address information for the back-end server 120 (220), requesting, by a remote client system 140, a list of digital-print files and transmitting, by the back-end server 120, the list of digital print files to the remote client system 140 (230), requesting, by a remote client system 140, a digital-preview file and transmitting, by the back-end server 120, the digital-preview file to the remote client system 140 (240), receiving, from a remote client system 140, a purchase order for a digital-print file (250), inserting, in response to the purchase order, a digital watermark into the digital-print file (260), and/or transmitting, to the remote client system 140, the watermarked digital-print file (270).

Digital-print files stored on the back-end server 120 include sheet music information that is used to visually display symbols, which represent aurally perceived music, on paper and/or, on a computer visual display device. Examples of musical symbols include lines (e.g., staff, bar lines), clefs (e.g., bass clef), notes and rests (e.g., quarter note), accidentals (e.g., flat, sharp), note relationships (e.g., tie, slur), and dynamics (e.g., pianissimo, forte). In some embodiments, a digital-print file including musical symbols can be formatted according to the Portable Document Format (PDF) standard. In some embodiments, a digital-print file including musical symbols can be formatted according to a digital image standard such as, for example, a Joint Photographic Experts Group (JPEG) standard or the Graphics Interchange Format (GIF).

Digital-audio files stored on the back-end server 120 include audio information that can be used to playback sound on a speaker device. Digital-audio files can include a synthetic rendering of what the arrangement sounds like and/or an actual recording of music by one or more performers. In some embodiments, a digital-audio file can be formatted according to a Moving Picture Experts Group (MPEG) format (e.g., as an .MP3 file), a Waveform Audio File (WAY) format (e.g., as a .WAV file), a Musical Instrument Digital Interface (MIDI) message (e.g., as a .MID file), a MusicXML music notation file format, and/or other audio file formats.

The sheet music information included in the digital-print files can be associated with one or more of the digital-audio files. Similarly, digital-audio files can be associated with one or more of the digital-print files. In some embodiments, relationships between the digital files can be established and/or managed via a relational database. In alternative or supplemental embodiments, associations between digital-audio files and digital-print files cam be accomplished by associating a unique identifier to the files (e.g., including a unique number or name as metadata or as the name to the files). For example, the audio of a portion or all of a song can be recorded as “song-name.MP3.” The digital-audio file “song-name.MP3” can be associated with the digital-print file “song.name.PDF,” which includes the music sheet information that represents the audio on “song.name.MP3.”

Digital-print files and/or digital-audio files can also be associated with one or more audio identifiers. In some embodiments, the audio identifiers can be stored as metadata in the digital files. Audio identifiers can include performer identifiers (e.g., the name of the band or singer that performed the music recorded on a digital-audio file), composer identifiers (e.g., the name of the writer/author of the music), arranger identifiers (e.g., the name of the arranger who created the sheet music), or any combination thereof. In some embodiments, audio identifiers can also include genre identifiers (e.g., rock, classical, blues, etc.), transcription-type identifiers (e.g., full transcription, piano-vocal transcription, guitar tab, guitar-vocal transcription, etc.), and/or best-seller identifier (e.g., music on the Billboard 200 chart).

Operators of the back-end server 120 can secure digital sheet music rights for digital-print and/or digital-audio from composers, music publishers, and/or other copyright owners, associated with one or more of the front-end servers 130. In some embodiments, the operators of the back-end server 120 can agree to provide hosting/store services to sell another party's sheet music using the other party's front-end server 130 as a transparent interface between a customer using a remote client system 140 and the back-end server 120.

In order to use the front-end server 130 as an interface to the API of the back-end server 120, computer network address information (e.g., IP address and/or domain name) for the back-end server 120 can be provided to the front-end server(s) 130 (220). For example, a front-end server 130 can host a webpage for a musical artist that includes an embedded graphical user interface (GUI) within the webpage that communicates directly with the back-end server 120 based on the previously provided address information. By embedding the GUI within the webpage from the front-end server 130, communications between the remote client system 140 and the back-end server 120 are transparent to the user of the remote client system 140. In some embodiments, the embedded GUI can be embedded as a link (e.g., <script src=“http://widget.back-end-server120.com/widget.js”></script.>) to a javascript software application that is retrieved from the back-end server 120 to run on the web browser of the remote client system 140. In alternative or supplemental embodiments, a javascript software application can be fully or partially embedded directly into the webpage stored on the front-end server 130. In yet further embodiments, the remote client system 140 can communicate with a software application running on a front-end server 130, which, in turn, communicates with the back-end server 120 using the API.

The front-end servers 130 can also provide one or more audio identifiers to the back-end server 120 and/or the remote client system 140 to use in communicating with the back-end server 120. In some embodiments, an audio identifier that lists the name of the performer can be embedded in the front-end server 130's webpage (e.g., <script> createWidget ({width: 900, height: 500, performer: ‘performer_name’});</script>). As described in more detail below, by providing an audio identifier (e.g., a performer's name) associated with the front-end server 130 to the back-end server 120 and/or to the remote client system 140 via the front-end server 130's webpage, the back-end server 120 will advantageously be able to provide access only to information associated with the audio identifier from the front-end server 130.

After a remote client system 140, for example, has retrieved a webpage from the front-end server 130, instructions can automatically cause either the remote client system 140's web, browser or the front-end server 130 to request, using the API, a list of digital-print files associated with an audio identifier that are currently stored on the back-end server 120 (230). Upon receiving the request via its API, the back-end server 120 can generate a list of digital-print files that are stored on its computer-readable storage medium by matching all, or a subset thereof, digital-print files that are associated with the requested audio identifier. For example, if the request is for a certain performer, then only a list of those digital-print files associated with that performer are retrieved and transmitted (230) to the remote client system 140 (e.g., the list can identify the names of all songs and/or types of available arrangements, which can include different transcriptions, by the performer that have corresponding digital-print files stored on the back-end server 120). In some embodiments, the generated list conforms to an eXtensible Markup Language (XML) format.

In some embodiments, the request for the list of digital-print files can further include geographic information associated with the remote client system 140. In this case, upon receiving the request via its API, the back-end server 120 can generate a list of digital-print files by matching all, or a subset thereof, digital-print files that are associated both with the requested audio identifier and with the geographic information. Being able to filter the available digital-print files based on geographic location advantageously allows the back-end server 120 to comply with copyright laws and/or any location-specific copyright license(s) it has by only providing digital-print files to geographic locations that it has the copyright owner's authority to distribute such copies to.

Based on the retrieved list, a user of the remote client system 140 can preview an item on the list by selecting, for example, a preview icon on a GUI (e.g., embedded in the user's web browser) associated with a certain digital-print file. By selecting a preview icon, the software application running on the front-end server 130 or remote client system 140 sends a request for a digital preview file to the back-end server 120 using the API (240). The preview request can include a print-preview request, an audio-preview request, or both a print-preview and audio-preview request. For example, before a user decides to purchase a digital-print file of sheet music, they may wish to preview how the sheet music looks and/or listen to an audio playback corresponding to the selected sheet music (e.g., sound that reflects the musical details of the particular arrangement).

In some embodiments, a particular song can be associated with one or more arrangements of sheet music (e.g., one or more types of arrangements such as a full-transcription or a guitar-vocal only transcription), in which case multiple digital-print files including the respective sheet music information can be stored on the back-end server 120. Additional digital-print files can be stored on the back-end server 120 as digital preview files of other and separate digital-print file(s) (e.g., images of a selected set of one or more pages of the digital-print file(s)). In supplemental or alternative embodiments, a digital print-preview file can be based merely by taking a portion (e.g., a selected set of one or more pages) of an existing digital-print file. Similarly, an audio digital preview file can be based on at least one or more selected portions of a digital-audio file in the set of one or more digital-audio files.

In some embodiments, if the web browser user on remote client system 140 wishes to purchase a listed digital-print file, then an identifier for the listed digital-print file can be recorded in an online shopping cart associated with the web browser user. Once the user is satisfied, they can initiate a purchase order for one or more of the items in their shopping cart by, for example, entering the appropriate billing informations into their web browser, which then communicates the request to the back-end server 120 using the API (250).

Based on the purchase order, the back-end server 120 can retrieve the selected digital-print file(s) and insert a digital watermark into the retrieved digital-print file(s) (260). The digital watermark can include licensing information associated with a user of the remote client system. 140 and/or the purchase order. In some embodiments, inserting the digital watermark can be accomplished, for example, by overlaying licensing text in a corner of one or more pages of the selected digital-print file. In alternative or supplemental embodiments, inserting the digital watermark can be accomplished, for example, by embedding the licensing information as metadata in the selected digital-print file. The licensing information associated with the user of the remote client system 140 can include a unique identifier (e.g., the name of the user, and/or a sales transaction identifier). The licensing information associated with the purchase order can include, for example, the date of the sales transaction and/or the licensed number of copies, which can be used by copyright management software systems to prevent copies of the sheet music from being made beyond the licensed number.

In some embodiments, the watermarked digital-print file can be stored in a repository database accessibly by the purchaser at anytime within a predetermined or permanent period of time. In some embodiments, transmitting, to the remote client system 140, the watermarked digital-print file (270) can include transmitting the watermarked digital-print file to a local professional photocopier or music store for printing on standard and/or high quality paper.

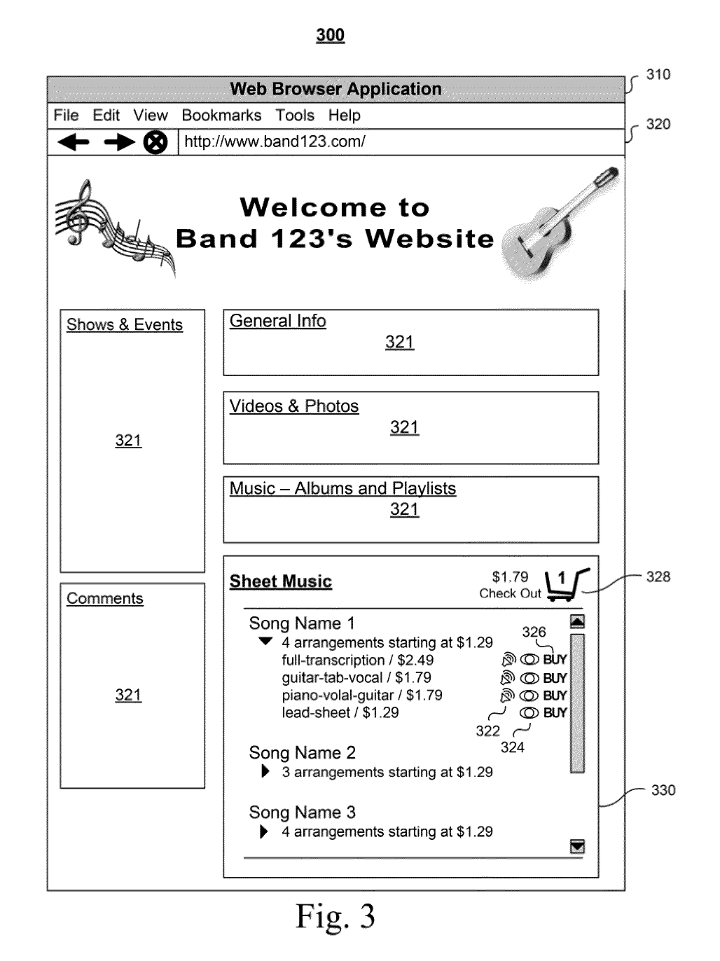

FIG. 3 illustrates a graphical user interface 300 depicting a web browser 310 on a remote client system 140. The web browser 310 includes a URL address bar 320 in which the web address for a fictional musical group “Band 123” has been entered. After the web browser has retrieved the webpage from the front-end server 130 hosting Band 123's website, the display window is populated with elements 321 from the downloaded webpage. In addition, the webpage that was downloaded also included an embedded GUI 330, which includes a software application that communicates with the API of the back-end server 120. GUI 330 includes a list of available sheet music (multiple arrangements for “Song Name 1,” “Song Name 2,” “Song Name 3,” etc.) for purchase from the back-end server 120. For each item in the list, the GUI provides the user the option to retrieve a digital-audio preview file by selecting icon 322, retrieve a digital-print preview file by selecting icon 324, and place a digital-print file in the user's shopping cart by selecting icon 326. A shopping cart icon 328 can indicate the number of digital-print files selected for purchase, the total cost of the selected purchases, and a “check out” selection to finalize the transaction.

In additional embodiments, operators of the back-end server 120 can obtain digital sheet music rights for music from composers, music publishers, and/or other copyright owners, in which the composers/music publishers are allowed to submit compositions (e.g., audio files) for sheet music publishing to the back-end server 120 or other repository database. Based on the submitted audio recording(s) of the respective music, the operators of the back-end server 120 can have the digital sheet music transcribed through, for example, an open or closed network of music arrangers. In some embodiments, the audio recording(s) of the music can be stored on the back-end server 120 and made accessible via the network 110 to selected arrangers. After the music has been transcribed, the arrangers can upload the sheet music as digital-print files back to the back-end server 120 via the network 110. Based on financial information for purchases recorded by the hack-end server 120, revenue and proceeds can be reported to and divided among the appropriate parties (e.g., an arranger can receive a percentage of the sales of sheet music that they created, composers/music publishers can receive a percentage of the sales of sheet music that they licensed to the operators of the back-end server 120, operators of the front-end servers 130 that referred purchases can receive a percentage of their referral sales).

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The hack-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system (e.g., a cloud-computing system) that includes any combination of such back-end, middleware, or front-end components.

The computing system can include clients and servers. A client and a server are generally remote from each other and typically interact through a communication network. The relationship of client and server arises by virtue of computer programs running on the respective computers and having a client-server relationship to each other.

The transmission medium 110 can include one or more packet-based networks and/or one or more circuit-based networks in any configuration. Packet-based networks can include, for example, an Ethernet-based network (e.g., traditional Ethernet as defined by the IEEE or Carrier Ethernet as defined by the Metro Ethernet Forum (MEF)), an ATM-based network, a carrier Internet Protocol (IP) network (e.g., local area network (LAN), wide area network (WAN), campus area network (CAN), metropolitan area network (MAN), home area network (HAN), or the like), a private IP network, an IP private branch exchange (IPBX), a wireless network (e.g., a Radio Access Network (RAN), 802.11 network, 802.16 network, general packet radio service (GPRS) network, HiperLAN, or the like), and/or other packet-based networks. Circuit-based networks can include, for example, the Public Switched Telephone Network (PSTN), a legacy private branch exchange (PBX), a wireless network (e.g., a RAN), bluetooth, code-division multiple access (CDMA) network, time division multiple access (TDMA) network, global system for mobile communications (GSM) network), and/or other circuit-based networks. Information transfer over the transmission medium 110 can also be based on, for example, Peer-to-Peer (P2P), Hypertext Transfer Protocol (HTTP), Session Initiation Protocol (SIP), Really Simple Syndication (RSS), podcasting, Global System for Mobile Communications (GSM), and/or other communication protocols.

Devices of the computing system can include, for example, a computer, a computer with a browser device, a telephone, an IP phone, a mobile device (e.g., tablet device, handheld device, smartphone, cellular phone, personal digital assistant (PDA) device, laptop computer, electronic mail device), a server, a rack with one or more processing cards, special purpose circuitry, and/or other communication devices. The browser device includes, for example, a computer (e.g., desktop computer, laptop computer, mobile device) with a world wide web browser (e.g., Microsoft® Internet Explorer® available from Microsoft Corporation, Mozilla® Firefox available from Mozilla Corporation).

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed:

1. A computer-implemented method for distributing printed sheet music, comprising:
storing a set of one or more digital-print files and a set of one or more digital-audio files in a computer-readable storage medium on a back-end server, each digital-print file including sheet music information associated with one of the digital-audio files, each digital-print file and digital-audio file being associated with one or more audio identifiers;
providing an application programming interface (API) for client systems remote from the back-end server to retrieve a list of the set of one or more digital-print files and to preview the digital-audio and digital-print files;
providing, to one or more front-end servers remote from the back-end server, computer network address information for accessing the API, each of the one or more front-end servers being associated with one or more of the one or more audio identifiers;
receiving, from a remote client system using the API, a preview request for a first digital-print file in the set of one or more digital-print files;
transmitting, in response to the preview request, a digital preview file associated with the first digital-print file to the remote client system;
receiving, from the remote client system using the API, a purchase order for the first digital-print file;
inserting, in response to the purchase order, a digital watermark into the first digital-print file, the digital watermark including licensing information associated with a user of the remote client system and the purchase order; and
transmitting, to the remote client system, the watermarked digital-print file.

2. The method of claim 1 wherein the API communicates with a software application on a front-end server from the one or more front-end servers, the software application including: the computer network address information for accessing the API, at least one audio identifier from the one or more audio identifiers, and instructions being operable to cause the front-end server to communicate with the API.

3. The method of claim 1 wherein the API communicates with a software application on the remote client system, the software application including: the computer network address information for accessing the API, at least one audio identifier from the one or more audio identifiers, and instructions being operable to cause the remote client system to communicate with the API.

4. The method of claim 3 wherein the software application on the remote client system is embedded in a webpage retrieved from a front-end server from the one or more front-end servers, and the at least one audio identifier is an audio identifier associated with the front-end server.

5. The method of claim 3 wherein the software application on the remote client system is retrieved from the back-end server based on the computer network address information being embedded in a webpage retrieved from a front-end server from the one or more front-end servers, and the at least one audio identifier is an audio identifier associated with the front-end server.

6. The method of claim 1 wherein the one or more audio identifiers comprise one or more performer identifiers, one or more composer identifiers, one or more arranger identifiers, one or more genre identifiers, one or more arrangement type identifiers, or any combination thereof.

7. The method of claim 6 wherein the one or more performer identifiers are associated with one or more names whose audio performances were recorded in the one or more digital-audio files, the one or more composer identifiers are associated with one or more names who wrote the music associated with the one or more digital-audio files, and the one or more arranger identifiers are associated with one or more names who transcribed the sheet music information associated with the digital-audio files.

8. The method of claim 1 wherein the API comprises a web interface conforming to the Representational State Transfer (REST) architecture, the Simple Object Access Protocol (SOAP), or any combination thereof.

9. The method of claim 1 further comprising:
receiving, from the remote client system using the API, a request to retrieve the list of the set of one or more digital-print files, the request including at least a first audio identifier from the one or more audio identifiers;
generating the list of the set of one or more digital-print files, the list including each digital-print file from the one or more digital-print files with an associated audio identifier that matches the first audio identifier; and
transmitting, to the remote client system, the list of the set of one or more digital-print files.

10. The method of claim 9 wherein generating the list of the set of one or more digital-print files is based on a geographic location associated with the remote client system.

11. The method of claim 9 wherein the list of the set of one or more digital-print files conforms to an eXtensible Markup Language (XML) format.

12. The method of claim 1 wherein the preview request comprises a print-preview request for the first digital-print file.

13. The method of claim 12 wherein the digital preview file is a digital image, and the set of one or more digital-print files includes the digital image separate from the first digital-print file.

14. The method of claim 12 wherein the digital preview file comprises at least a portion of the first digital-print file.

15. The method of claim 1 wherein the preview request comprises an audio-preview request for the first digital-print file.

16. The method of claim 15 wherein the digital preview file comprises at least a portion of a first digital-audio file in the set of one or more digital-audio files, the first digital-audio file associated with the first digital-print file.

17. The method of claim 1 further comprising receiving, from the remote client system using the API, a second preview request for the first digital-print file, the preview request and the second preview request comprising audio-preview and print-preview requests for the first digital-print file.

18. The method of claim 1 wherein the watermarked digital-print file comprises a digital file formatted according to the Portable Document Format (PDF) standard.

19. The method of claim 1 wherein the licensing information associated with the user of the remote client system and the purchase order comprises a unique identifier for the user of the remote client system.

20. The method of claim 1 further comprising receiving, from the remote client system using the API, a request to add the first digital-print file to an online shopping cart.

21. A computer program product, tangibly embodied in a machine-readable storage device, the computer program product including instructions being operable to cause a data processing apparatus to:
store a set of one or more digital-print files and a set of one or more digital-audio files in a computer-readable storage medium on a back-end server, each digital-print file including sheet music information associated with one of the digital-audio files, each digital-print file and digital-audio file being associated with one or more audio identifiers;
provide an application programming interface (API) for client systems remote from the back-end server to retrieve a list of the set of one or more digital-print files and to preview the digital-audio and digital-print files;
provide, to one or more front-end servers remote from the back-end server, computer network address information for accessing the API, each of the one or more front-end servers being associated with one or more of the one or more audio identifiers;
receive, from a remote client system using the API, a preview request for a first digital-print file in the set of one or more digital-print files;
transmit, in response to the preview request, a digital preview file associated with the first digital-print file to the remote client system;
receive, from the remote client system using the API, a purchase order for the first digital-print file;
insert, in response to the purchase order, a digital watermark into the first digital-print file, the digital watermark including licensing information associated with a user of the remote client system and the purchase order; and
transmit, to the remote client system, the watermarked digital-print file.

22. A computer system for distributing printed sheet music, comprising:
a back-end server including a computer-readable storage medium, the computer-readable storage medium including a set of one or more digital-print files and a set of one or more digital-audio files, each digital-print file including sheet music information associated with one of the digital-audio files, each digital-print file and digital-audio file being associated with one or more audio identifiers, the back-end server including an application programming interface (API) for client systems remote from the back-end server to retrieve a list of the set of one or more digital-print files and to preview the digital-audio and digital-print files;
means for receiving, from a remote client system using the API, a preview request for a first digital-print file in the set of one or more digital-print files;
means for transmitting, in response to the preview request, a digital preview file associated with the first digital-print file to the remote client system;
means for receiving, from the remote client system using the API, a purchase order for the first digital-print file;
means for inserting, in response to the purchase order, a digital watermark into the first digital-print file, the digital watermark including licensing information associated with a user of the remote client system and the purchase order; and
means for transmitting, to the remote client system, the watermarked digital-print file.
